(19) United States
(12) Patent Application Publication
(10) Pub. No.: US 2008/0304941 A1
(43) Pub. Date: Dec. 11, 2008

(54) Multi-Stage Baking Apparatus for Plasma Display Panel

(76) Inventors: Makoto Morita, Osaka (JP); Masanori Suzuki, Osaka (JP); Hiroyasu Tuji, Osaka (JP); Michiro Aoki, Aichi (JP); Hirohito Adachi, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 10/580,201

(22) PCT Filed: Nov. 25, 2004
(86) PCT No.: PCT/JP2004/017496

§ 371 Date: Jun. 12, 2008

(30) Foreign Application Priority Data
Nov. 26, 2003 (JP) 2003-394834

(51) Int. Cl. F27B 9/24

(52) U.S. Cl. 414/196

(57) ABSTRACT

The present invention intends to provide a baking apparatus for PDP capable of realizing an improvement in productivity while minimizing an increase in a factory space. In a baking furnace 2 for performing heat treatment while conveying substrates 4, conveying means 6 of multiple stages for conveying substrates are provided. The conveying means 6 adjacent in an up and down direction are divided with heat insulating partitions 7 provided between them so as to form a multi-stage furnace, and heating means 9 are provided appropriately to the heat insulating partitions 7. In each furnace of the multi-stage furnace, a heating area, a keeping area and a cooling area are formed in order in the traveling direction of the conveying means, whereby baking of plasma display panels is performed in multiple stages.

### TECHNICAL FIELD

The present invention relates to a multi-stage baking apparatus for plasma display panels, which bakes substrates of plasma display panels (PDP) on which functional film materials are formed.

### BACKGROUND ART

In industries, functional film materials consisting of metal, inorganic materials and organic materials are often formed across a substrate made of glass or ceramics by using various methods such as application, printing, die coating, sheet attachment, vacuum evaporation and sputtering, or patterned by photolithography or masking.

On a substrate for PDP, there are formed metal wiring such as electrodes, transparent electrode films, insulators for maintaining insulation or dielectrics, or functional film materials such as partitions for dividing a plurality of phosphors or electron discharge films.

To these functional film members, baking is performed for improving adhesive properties due to heat diffusion of materials, adjusting crystalline orientation, melting metal on interfaces, maintaining and enhancing proper resistance values and shapes, removing unnecessary substances and the like.

Note that in the description below, baking means a heat treatment such as rise in temperature, constant temperature and fall in temperature of processed materials, or combinations thereof, which indicates a heat treatment by raising or lowering the temperature or keeping the temperature constant of the processed materials, or by combining some of them.

The heat treatment for forming functional film materials as described above is a process requiring relative long time. In order to improve the productivity, a baking apparatus in which processed materials are baked by being conveyed by a mesh belt conveyer, a roller conveyer or the like in a dome-shaped or tunnel-shaped baking furnace, for example, is often used in general (see, for example, “2001 FPD Technology Outlook”, published by Electronic Journal, Inc., Oct. 25, 2000, p. 672 to p. 675, p. 680 to p. 682.

### DISCLOSURE OF INVENTION

### Problems to be Solved by the Invention

In order to improve the productivity of PDP, it is effective to reduce the heat treatment time. However, there is a limit in reducing the baking time because of the characteristics of film materials, crack and deformation of glass substrates and the like.

Further, although there is a case where substantial heat treatment time is reduced by performing heat treatment to plural numbers of substrates collectively, the baking apparatus must be larger in such a case, so the factory space is required to be increased.

That is, there has been a case of adopting a method of increasing a number of substrates capable of being treated in the same space with a baking furnace having a multi-stage configuration in which a plurality of typical baking furnaces are piled up. However, since an outer height of an existing baking furnace is high, when adopting multiple stages, in the case of typical height (4.5 m or less) of a factory room, a configuration in which baking furnaces 31, 31 are piled up in two stages and a return conveyer 34 for returning setters 33 for mounting substrates 32 is provided thereunder, as shown in FIG. 5A, is the limit, practically.

Further, in the case of a configuration in which the baking furnaces 31, 31, 31 are piled up in three stages as shown in FIG. 5B, the return conveyer 34 must be provided outside the mounting space of the baking furnaces 31. This causes the space to be increased, whereby it is not practical.

Further, as shown in FIG. 5C, there has been a case of adopting a method in which the substrates 32 are piled up for a plurality of stages (two stages in FIG. 5C) at predetermined interval in the baking furnace 31, and heat treatment is performed in this state. In such a case, it is required to set the time for heating and cooling the substrates 32 longer, and the heat histories of the substrates 32 at each stage are different, whereby there may be a problem that baked states of the substrates 32 become different.

The present invention has been developed in view of the problem described above. It is therefore an object of the present invention to provide a baking apparatus for PDP capable of realizing an improvement in the productivity while suppressing an increase in a factory space to the minimum.

### Means for Solving the Problems

In order to realize the above-mentioned object, the present inventors have studied intensively, and in view of the fact that substrates of PDP are large in size and thin, they finally found that it is possible to bake without any problem by forming a multi-stage baking furnace in which a heating area, a keeping area and a cooling area are provided in order in the conveying direction, whereby the present invention has been completed. A baking apparatus for PDP of the present invention is characterized in that conveying means of multiple stages for conveying substrates are provided in the baking furnace. The conveying means adjacent in an up and down direction are divided with heat insulating partitions provided between them so as to form a multi-stage furnace, and heating means are provided appropriately to the heat insulating partitions. In each furnace of the multi-stage furnace, a heating area, a keeping area and a cooling area are formed in order in the traveling direction of the conveying means.

### Effect of the Invention

According to the present invention, a baking apparatus for plasma display panels is capable of realizing a baking furnace of a multi-stage structure in a state where the space in a height direction is suppressed to the minimum. Thereby, it is possible to realize an improvement in the productivity while minimizing an increase in a factory space. Further, the apparatus has an advantage of suppressing of heat escape comparing with a conventional one in which furnaces are piled, whereby the heat efficiency is improved.

### BRIEF DESCRIPTION OF DRAWINGS

FIG. 1 is a sectional perspective view showing the schematic configuration of a plasma display panel manufactured according to a first embodiment of the present invention;

FIG. 2 is a flowchart showing the overall flow of the manufacturing steps by a baking apparatus for plasma display panels according to the first embodiment of the present invention;

FIG. 3 is a cross-sectional front view of the baking apparatus for plasma display panels according to the first embodiment of the present invention;

FIG. 4 is a cross-sectional side view of a heating area of the baking apparatus for plasma display panels according to the first embodiment of the present invention; and

FIGS. 5A, 5B and 5C are cross-sectional side views of a conventional baking apparatus for plasma display panels.

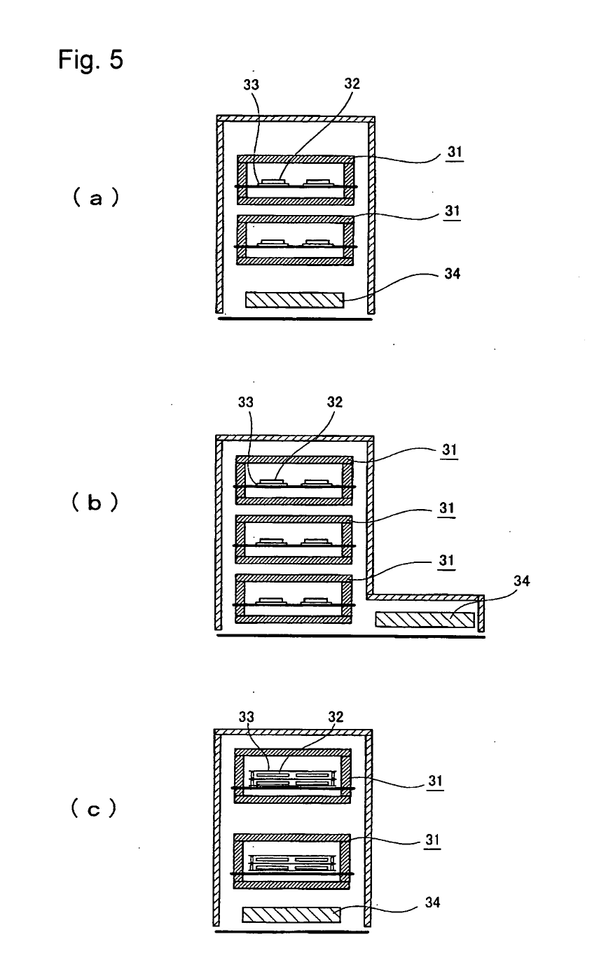

### BEST MODE FOR CARRYING OUT THE INVENTION

A multi-stage baking furnace of the present invention is a baking apparatus for plasma display panels having a baking furnace for performing heat treatment to substrates while conveying the substrates. In the baking furnace, conveying means for conveying substrates are divided into multiple stages with heat insulating walls provided between them adjacent in an up and down direction, and a heating means is arranged appropriately to each of the heat insulating walls of multiple stages so as to form a heating area, a keeping area and a cooling area in order in the traveling direction of the conveying means in each furnace of the multi-stage furnace.

Further, since the heating means form a heating area, a keeping area and a cooling area in order in the traveling direction of the conveying means in each furnace, the heating means may be configured to be able to suppress the heating amount separately, or configured to be able to control the heating amount for each temperature zone provided in the conveying direction of substrates.

Generally, it is preferable that the heating means be an electric heater, and in the baking furnace, a return conveyer be provided under the multi-stage conveying means for conveying substrates.

Hereinafter, a baking apparatus for PDP according to an embodiment of the present invention will be described by using drawings.

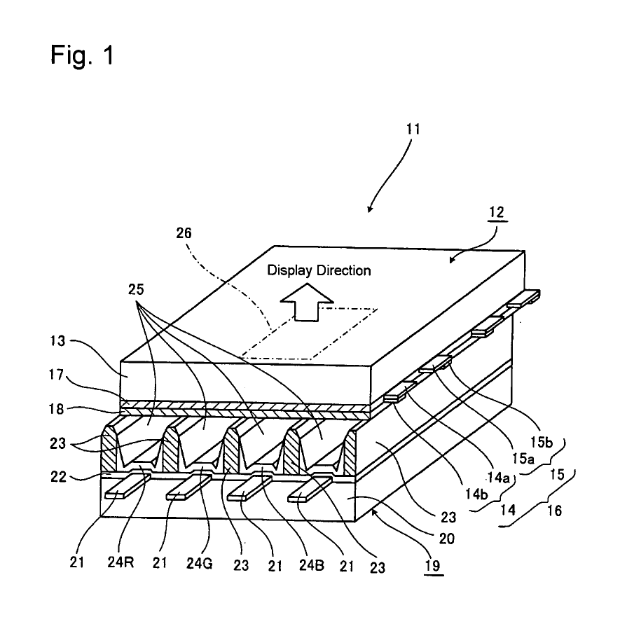

FIG. 1 is a sectional perspective view showing the schematic configuration of a PDP of surface discharge type having three-electrode configuration.

A front surface plate 12 of a PDP 11 is so configured that a plurality of display electrodes 16 consisting of scan electrodes 14 and sustain electrodes 15 are formed on a substrate 13 which is smooth, transparent and insulative such as float glass, and a dielectric layer 17 is formed so as to cover the display electrodes 16, and further a protective layer 18 made of MgO is formed on the dielectric layer 17. Note that the scan electrodes 14 and the sustain electrode 15 consist of transparent electrodes 14a and 15a serving as discharge electrodes and bus electrodes 14b and 15b made of Cr/Cu/Cr or Ag or the like electrically connected with the transparent electrodes 14a and 15a, respectively.

Further, a back surface plate 19 is so configured that a plurality of address electrodes 21 are formed on an insulative substrate 20 such as glass, and a dielectric layer 22 is formed so as to cover the address electrodes 21. Then, partitions 23 are provided at positions on the dielectric layer 22 corresponding to positions between the address electrodes 21, and phosphor layers 24R, 24G and 24B of read, green and blue colors are provided on the surface parts of the dielectric payer 22 to the side faces of the partitions 23.

The front surface plate 12 and the back surface plate 19 are arranged opposite each other with the partitions 23 between them such that the display electrodes 16 and the address electrodes 21 cross at right angle and discharge spaces 25 are formed.

In the discharge spaces 25, at least one kind of inert gas, among helium, neon, argon and xenon, is filled as a discharge gas. The discharge spaces 25 are divided by the partitions 23, and the discharge spaces 25 at the crossing part of the address electrodes 21, the scan electrodes 16 and the sustain electrodes 17 operate as discharge cells. By applying periodical voltage to the address electrodes 11 and the display electrodes 16, discharge is generated, and by irradiating an ultraviolet lay due to the discharge to the phosphor layer 14 and converting it to visible light, image display is performed.

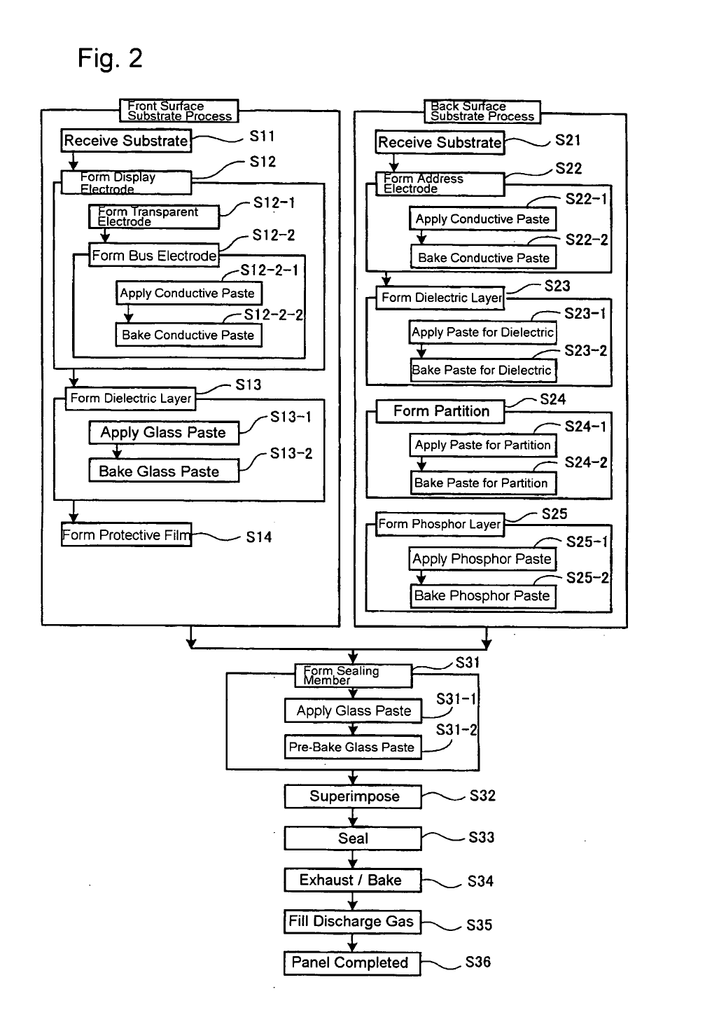

Next, a method of manufacturing a PDP having the configuration described above will be explained by using FIG. 2. FIG. 2 is a flowchart showing the steps of manufacturing a PDP manufactured by using the baking apparatus according to the first embodiment of the present invention.

First, a front surface plate process for manufacturing the front surface plate 12 will be described.

After a substrate receiving step (S11) for receiving the substrate 13, a display electrode forming step (S12) is performed to form display electrodes 16 on the substrate 13. This includes a transparent electrode forming step (S12-1) for forming the transparent electrodes 14a and 15a, and a subsequent bus electrode forming step (S12-2) for forming the bus electrodes 14b and 15b. The bus electrode forming step (S12-2) includes a conductive paste applying step (S12-2-1) for applying a conductive paste such as Ag by screen printing or the like, and a subsequent conductive paste baking step (S12-2-2) for baking the applied conductive paste. Next, a dielectric layer forming step (S13) is performed to form the dielectric layer 17 so as to cover the display electrodes 16 formed in the display electrode forming steps (S12). The dielectric layer forming step (S13) includes a glass paste applying step (S13-1) for applying a paste including a lead-based glass material (the composition is, for example, lead oxide [PbO] 70 weight %, boron oxide [B₂O₃] 15 weight %, and silicon oxide [SiO₂] 15 weight %) by a screen printing method, and a subsequent glass paste baking step (S13-2) for baking the applied glass material. Then, a protective film forming step (S14) is performed to form the protective film 18 made of magnesium oxide (MgO) or the like on the surface of the dielectric layer 17 by a vacuum evaporation method or the like. Through these steps, the front surface plate 12 is manufactured.

Next, a back substrate process for manufacturing the back surface plate 19 will be explained. After a receiving step (S21) for receiving the substrate 20, an address electrode forming step (S22) is performed to form the address electrodes 21 on the substrate 20. This includes a conductive paste applying step (S22-1) for applying a conductive paste such as Ag by screen printing or the like, and a subsequent conductive paste baking step (S22-2) for baking the applied conductive paste. Next, a dielectric layer forming step (S23) is performed to form the dielectric layer 22 on the address electrodes 21. This includes a paste for dielectric applying step (23-1) for applying a paste for dielectric including TiO₂ particles and dielectric glass particles by screen printing or the like, and a subsequent paste for dielectric baking step (23-2) for baking the applied paste for dielectric. Next, a partition forming step (S24) is performed to form the partitions 23 at positions on the dielectric layer 22 corresponding to the parts between the address electrodes 21. This includes a paste for partition applying step (S24-1) for applying paste for partitions including glass particles by printing or the like, and a subsequent paste for partition baking step (S24-2) for baking the applied paste for partition. Then, a phosphor layer forming step (S25) is performed to form the phosphor layers 24R, 24G and 24B between the partitions 23. This includes a phosphor paste applying step (S25-2) for producing phosphor pastes of the respective colors of red, green and blue and applying them in the gaps between the partitions, and a subsequent phosphor paste baking step (S25-2) for baking the applied phosphor pastes. Through these steps, the back surface plate 19 is manufactured.

Next, sealing of the front surface plate 12 and the back surface plate 19 manufactured as described above, vacuum exhaust performed thereafter, and filling of a discharge gas will be described. First, a sealing member forming step (S31) is performed to form a sealing member made of glass frit on at least one of the front surface plate 12 and the back surface plate 19. This includes a step of applying glass paste for sealing (S31-1) in which the glass frit is in a paste state, and a subsequent glass paste pre-baking step (S31-2) for pre-baking to remove resin components and the like of the applied glass paste. Next, a superimposing step (S32) for superimposing is performed such that the display electrodes 16 of the front surface plate 12 and the address electrodes 21 of the back surface plate 19 face each other and cross at right angle. Then, a sealing step (S33) is performed by heating the superimposed both substrates 12 and 19 so as to soften the sealing member to thereby seal them. Next, an exhausting/baking step (S34) is performed to bake while performing vacuum exhaust in fine discharge spaces 25 formed by the sealed both substrates 12 and 19, then a discharge gas filling step (S35) is performed to fill in a discharge gas at a predetermined pressure. Thereby, the PDP 21 is completed (S36).

Here, explanation will be given for a baking apparatus used in a baking step of a forming step of the bus electrodes 14b and 15b, the dielectric layer 17, the address electrodes 21, the dielectric layer 22, the partitions 23, the phosphor layers 24R, 25G and 24B, and sealing members (not shown), which are panel structures, in the manufacturing method described above.

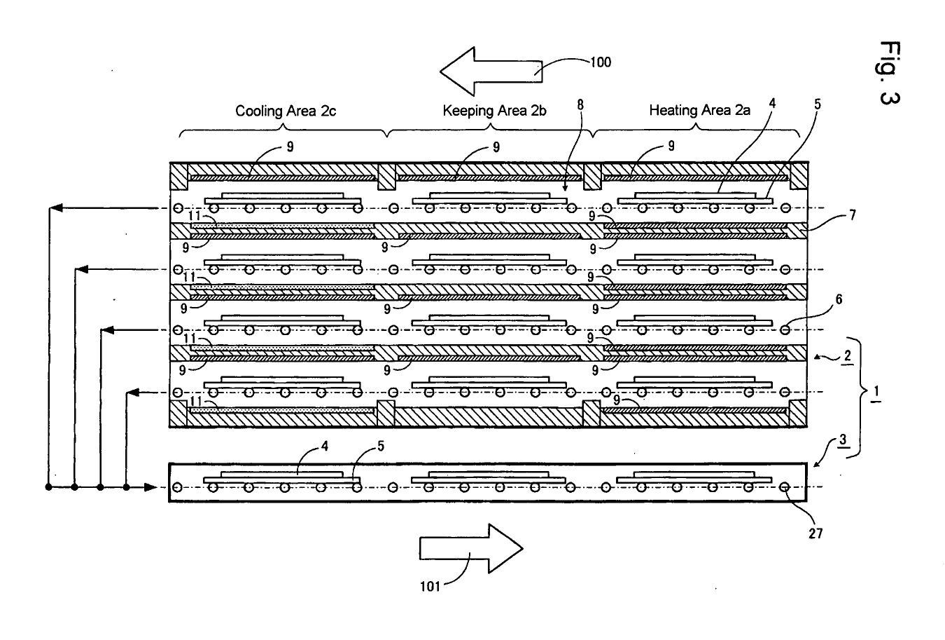

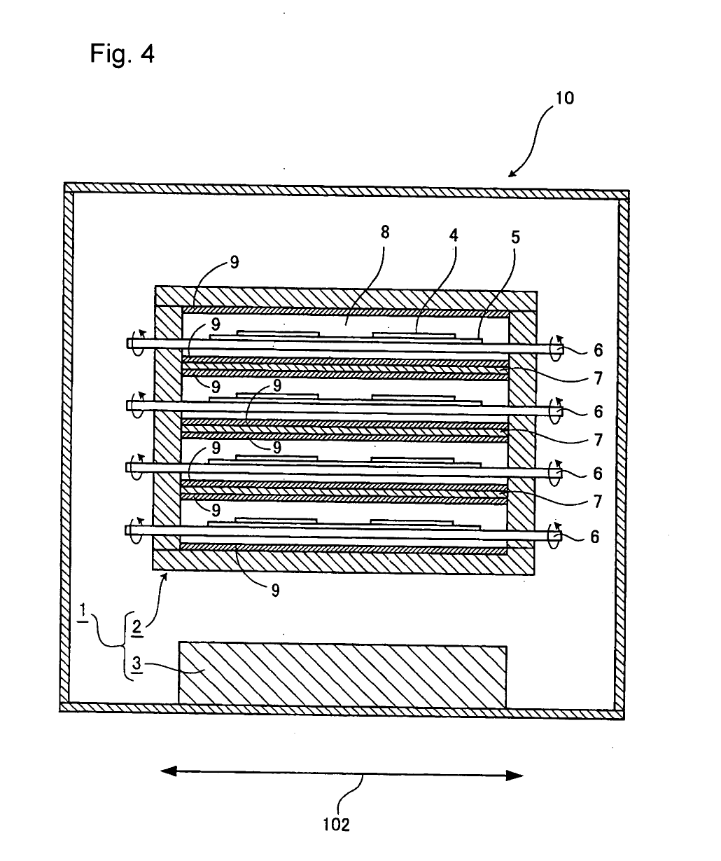

FIG. 3 shows a baking apparatus for plasma display panels of the first embodiment of the present invention. The reference numeral 100 indicates the conveying direction of substrates 4 to be baked. FIG. 4 is a sectional view of a heating area in FIG. 3, and the reference numeral 102 indicates the width direction orthogonal to the conveying direction 100.

The baking apparatus 1 is configured to include a baking furnace 2 and a return conveyer 3 provided thereunder.

In the baking furnace 2, as a conveying means for conveying setters 5 mounting substrates 4 serving as substrates 13 of the front surface plates 12 or substrates 20 of the back surface plates 19 of PDP 11, the roller conveyers 6, for example, are provided in four lines for example. Between the respective lines, heat insulating walls 7 having the heat insulating structure are provided, and with the heat insulating walls 7, inside of the baking furnace 2 is divided to constitute heat treatment rooms 8. Further, electric heaters 9, for example, are provided as heating means on the top and bottom faces of the heat insulating walls 7 and the ceiling and the floor of the baking furnace 2. Each electric heater 9 may be divided into some pieces in the width direction 102 corresponding to the size of the heat treatment room 8, and controlled to obtain the target temperature distribution.

On the lower side of the baking furnace 2, a return conveyer 3 for returning setters 5 or setters 5 on which the baked substrates are mounted is provided, and the baking apparatus 1 is covered with a protective cover 10.

Here, the baking furnace 2 includes, along the conveying direction 100, a heating area 2a for heating the substrates 4 and the setters 5 for mounting them up to a set temperature, a keeping area 2b for performing heat treatment to them at a constant temperature, and a cooling area 2c for cooling them up to a predetermined temperature.

In the heating area 2a, the electric heaters 9 are provided on the top and bottom faces of the heat insulating walls 7 and the ceiling and the floor of the baking furnace 2 such that the electric heaters 9 are arranged on the top and bottom faces of the heat treatment rooms 8.

Further, in the keeping area 2b, since it is only required to keep the substrate 4 and the setter 5 mounting them at a constant temperature, a configuration that the electric heater 9 is provided to only one surface of the heat treatment room 8 may be adopted.

Further, in the cooling area 2c, the substrate 4 and the setter 5 for mounting them are cooled up to a predetermined temperature. Therefore, a configuration that the electric heater 9 is provided on one face of the heat treatment room 8 and a cooling means 11 is provided on the other face may be adopted.

Further, the heating area 2a, the keeping area 2b and the cooling area 2c as described above are so configured as to be divided into a plurality of areas in the conveying direction 100 according to a predetermined temperature setting.

Each electric heater 9 may be so configured as to be able to control the heating amount separately, or be so configured as to be able to at least control the heating amount for each temperature zone provided in the conveying direction of the substrates.

Further, the return conveyer 3 is so configured to include, for example, a roller conveyer 27 as a conveying means, similar to the baking furnace 2.

Further, various heat treatments can be realized in such a manner that in the heating area 2a, the keeping area 2b and the cooling area 2c of each of the heat treatment rooms 8 provided in four stages in an up and down direction, temperatures of the electric heaters are adjusted so as to be different in each stage, and those passing through the heat treatment room of the first stage and being baked are conveyed in the arrow 101 direction by the return conveyer 3, which is carried in the heat treatment room 8 of the second stage for example.

According to the baking apparatus for PDP having the configuration as described above, the heat treatment rooms 8 of multiple stages are formed not by piling existing baking apparatuses in an up and down direction but by dividing inside of the baking furnace in an up and down direction with the heat insulating walls 7, and the electric heaters 9 are provided on the heat insulating walls 7 whereby the heat treatment rooms 8 of the respective stages are configured to be controlled to a target baking temperature suitable for substrates for plasma display panels, respectively. Therefore, it is possible to realize baking apparatus having multi-stage structure even in a room height (4.5 m or less) of a general factory, comparing with conventional cases.

### INDUSTRIAL APPLICABILITY

According to the present invention, it is possible to realize a baking furnace having a multi-stage structure while suppressing the space in the height direction to the minimum, whereby it is possible to contribute to an improvement in the baking productivity of substrates for various display devices or the like besides substrates for PDP while suppressing an increase in the factory space to the minimum.

1. A multi-stage baking apparatus for a plasma display comprising a baking furnace for performing heat treatment to substrates while conveying the substrates, wherein
plural stages of conveying means for conveying the substrates are provided, and the conveying means adjacent in an up and down direction are divided with heat insulating partitions provided between them so as to have a multi-stage structure in the baking furnace, and heating means are provided appropriately to the heat insulating partitions within the baking furnace, and a heating area, a keeping area and a cooling area are provided in order in a traveling direction of the conveying means within each furnace of each of the multiple stages.

2. The multi-stage baking apparatus for a plasma display panel as claimed in claim 1, wherein the heating means in the baking furnace may be so configured as to be able to control a heating amount separately, or configured as to control a heating amount of each temperature zone provided in a conveying direction of the substrates.

3. The multi-stage baking apparatus for a plasma display panel as claimed in claim 1, wherein the heating means is an electric heater.

4. The multi-stage baking apparatus for a plasma display panel as claimed in claim 1, wherein a return conveyer is provided under the conveying means in multiple stages for conveying the substrates.
